(19) United States
(12) Patent Application Publication
(10) Pub. No.: US 2006/0028562 A1
(43) Pub. Date: Feb. 9, 2006

(54) Fast area-selected filtering for pixel-noise and analog artifacts reduction

(76) Inventors: Martin Schmitz, Braunschweig (DE); Victor J. Duvanenko, Indianapolis, IN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/913,475

(22) Filed: Aug. 9, 2004

(51) Int. Cl. H04N 5/217

(52) U.S. Cl. 348/241

(57) ABSTRACT

A method for processing a video signal having a plurality of sequential frames comprising an array of pixels each having a pixel value and arranged in a plurality of horizontal lines. The method includes receiving a selected frame of the video signal and processing the selected frame, wherein processing the selected frame includes determining an amount of motion of pixels of the selected frame, retaining pixel values of the pixels of the selected frame if the amount of motion in the pixels of the selected frame is greater than a pixel change threshold, and replacing the pixel values of the pixels of the selected frame with filtered pixel values if the amount of motion in the pixels of the selected frame is equal to or less than the pixel change threshold. The method further includes storing the retained pixel values and filtered pixel values of the selected frame.

### TECHNICAL FIELD

The present invention is in general related to video image processing methods and apparatus and, more particularly, to fast area-selected filtering methods and apparatus that reduce pixel noise and analog artifacts.

### BACKGROUND

Digital video cameras and analog video capturing devices have been widely used in recent years. The ever-greater amount of video images to be processed demand more and more advanced video compression techniques, an example of which is motion estimation that is generally applied to remove data redundancies. Also, during video capturing process, pixel noise and artifacts may be caused by the capturing devices. Thus, image filtering techniques are commonly applied to remove such pixel noise and artifacts.

A video signal comprises temporally consecutive, or sequential, frames of images. Each frame further comprises an array of pixels, which may also be viewed as being arranged in a plurality of horizontal lines. Each pixel typically has three color components: red, green, and blue.

Pixel noise may be described as a random offset in one or more of the color components of the pixels. Therefore, the pixel noise in one pixel of a frame is independent of the pixel noise in another pixel in that same or another frame. In contrast, artifacts are quasi-random offsets exhibiting inter-dependencies between pixels in a line.

In order to remove the pixel noise and artifacts, spatial or temporal filtering methods may be applied. Spatial filtering typically means replacing a pixel with an estimate based on the neighboring pixels thereof, while temporal filtering generally means replacing a pixel with an estimate based on values of that same pixel over time. However, spatial filtering tends to blur sharp edges of the images and therefore reduce the resolution, and temporal filtering may introduce motion blur if objects on the video move at a significant speed. It is therefore desirable to provide improved methods and apparatus for filtering video signals.

### SUMMARY

Methods and systems consistent with aspects and principles of the present invention may obviate one or more of the above and/or other problems by providing filtering only to selected areas where motions of objects are determined to be slow or still.

Consistent with aspects of the present invention, there is provided a method for processing a video signal having a plurality of sequential frames comprising an array of pixels each having a pixel value and arranged in a plurality of horizontal lines. The method includes receiving a selected frame of the video signal and processing the selected frame, wherein processing the selected frame includes determining an amount of motion of pixels of the selected frame, retaining pixel values of the pixels of the selected frame if the amount of motion in the pixels of the selected frame is greater than a pixel change threshold, and replacing the pixel values of the pixels of the selected frame with filtered pixel values if the amount of motion in the pixels of the selected frame is equal to or less than the pixel change threshold. The method further includes storing the retained pixel values and filtered pixel values of the selected frame.

Consistent with other aspects of the present invention, there is provided a computer system connectable to a video capturing device for receiving a video signal having a plurality of sequential frames comprising an array of pixels each having a pixel value and arranged in a plurality of horizontal lines. The system includes a memory for storing a set of instructions implementing a method for processing the plurality of sequential frames and a processor for executing the set of instructions. The method includes receiving a selected frame of the video signal and processing at least a first pixel of the selected frame, wherein processing at least a first pixel of the selected frame includes determining a first amount of pixel change in the first pixel, wherein the first pixel is in a first line of the selected frame, determining a second amount of pixel change in a second pixel, the second pixel being in a second line of the selected frame and vertically adjacent to the first pixel, determining a third amount of pixel change in a third pixel, the third pixel being in a third line of the selected frame and vertically adjacent to the first pixel, retaining the pixel value of the first pixel if at least two of the first, second, and third amounts of pixel change are greater than a pixel change threshold, and replacing the pixel value of the first pixel with a filtered pixel value if at least two of the first, second, and third amounts of pixel change are equal to or less than the pixel change threshold. The method further includes storing the pixel values and filtered pixel values of the selected frame.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

The foregoing background and summary are not intended to be comprehensive, but instead serve to help one skilled in the art understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is a logic flow diagram of a method for processing a video signal, consistent with the invention;

FIG. 2 is an image showing a person in the process of turning around;

FIG. 3 shows in black portions of the image of FIG. 1 that are not to be filtered, as determined by a filtering method consistent with the present invention; and

FIG. 4 shows a computer system in which the area-selected filtering method consistent with the present invention may be implemented.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention. Other implementations may be used and structural and procedural changes may be made without departing from the scope of present invention.

Consistent with aspects of the present invention, there is provided an area-selected filtering method and principle that obviate one or more problems of conventional filtering methods. By identifying pixels contained in still or in slow motion portions of an image and applying filtering thereto, the area-selected filtering method avoids possible image blur caused by spatial filtering and motion blur caused by temporal filtering.

In the following description, a video signal comprising progressive image frames is assumed. In other words, spatially consecutive lines of each frame of the video are also displayed consecutively. However, it is to be understood that the area-selected filtering method may also be applied for processing a video signal comprising interlaced images, which shall be apparent to one skilled in the art.

For illustration purposes, it is also assumed that each frame of the video comprises pixels each being represented by the horizontal position and vertical position thereof, wherein the horizontal position is labeled as x and the vertical position is labeled as y. Accordingly, (x, y) represents the pixel at a horizontal distance of x and a vertical distance of y from an origin of the frame.

A video frame at time t=t₀ which is currently being filtered is denoted as C and its temporal neighbors are denoted as P and F, wherein P is the previous frame at time t=t₀₋₁ and F is the future frame at time t=t₀₊₁. Thus, C(x,y) represents pixel (x, y) of frame C, etc. The three color components of a pixel may be respectively denoted by a subscript of r, g, or b. For example, Cᵣ(x,y) represents the red color component of pixel C(x,y), and a value of Cᵣ(x,y) indicates the intensity of red color component of pixel C(x,y). In the following description, the color components of each pixel are normalized to the range of 0 to 1. Thus, for example, a maximum value of Cᵣ(x,y) or C_{g}(x,y) is 1. The composition of all three color components may be represented by a vector, for example, [symbol] (x,y).

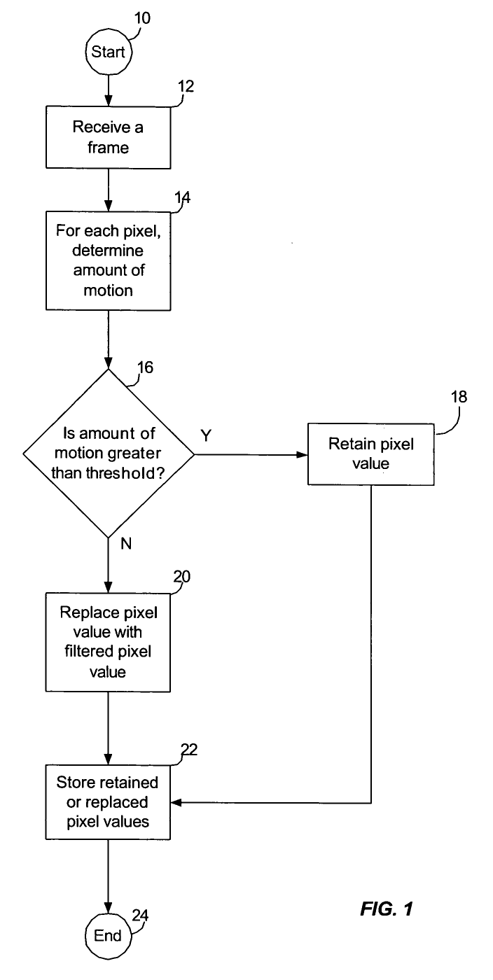

A method for processing a video signal, consistent with the invention, is shown in FIG. 1. The method begins at 10. First, at 12, a frame of video data is received. Next, at 14, the amount of motion of the pixel is determined. Then, at 16, for each pixel, it is determined whether that pixel is in a fast motion, that is, greater than a pixel change threshold. In one aspect, this may be achieved by comparing the values of that pixel between consecutive video frames. For example, by comparing the values of each color component of pixel (10, 20) on frames P, C, F, it may be determined, using techniques described below, whether pixel (10, 20) has fast motion.

However, due to the existence of pixel noise and artifacts, pixel (10, 20) in one frame, e.g., frame C, may not represent the true values of that pixel at time t=t₀, in which case a comparison between the values of pixel (10, 20) at frames P, C, F may erroneously indicate that pixel (10, 20) is in a fast or slow motion. To avoid this problem and consistent with the area-selected filtering method, a spatial average of several neighboring pixels, rather than a single pixel, may be compared over several consecutive frames.

For example, a sum [symbol] of three horizontally neighboring pixels including the pixel current being filtered, (x, y), is first calculated for each of frames P, C, F, as follows:

$$\begin{matrix}{{S}^{->}}_{P ( x , y )} = {\sum }_{i = - 1}^{i = 1} {P}^{->} ( x + i , y ) , & ( 1 ) \\ {{S}^{->}}_{C ( x , y )} = {\sum }_{i = - 1}^{i = 1} {C}^{->} ( x + i , y ) , & ( 2 ) \\ {{S}^{->}}_{F ( x , y )} = {\sum }_{i = - 1}^{i = 1} {F}^{->} ( x + i , y ) . & ( 3 )\end{matrix}$$

Each color component of the above sums may be expressed by adding a respective subscript. For example, the red component of [symbol] _{F(x,y)} may be denoted as [symbol] _{F(x,y),r}. Then, each color component of these sums is averaged and the temporal change thereof between frames P, C, F is calculated. A maximum pixel change M(x,y) is defined as follows:

$$M ( x , y ) = \frac{1}{3} max ( \vert {S}_{F ( x , y ) , r} - {S}_{C ( x , y ) , r} \vert , \vert {S}_{F ( x , y ) , g} - {S}_{C ( x , y ) , g} \vert , \vert {S}_{F ( x , y ) , b} - {S}_{C ( x , y ) , b} \vert , \vert {S}_{P ( x , y ) , r} - {S}_{C ( x , y ) , r} \vert , \vert {S}_{P ( x , y ) , g} - {S}_{C ( x , y ) , g} \vert , \vert {S}_{P ( x , y ) , b} - {S}_{C ( x , y ) , b} \vert ) . \qquad ( 4 )$$

Consistent with the area-selected filtering method, a pixel change threshold u is defined such that if
M(x,y)>u (5)
pixel (x,y) is considered in fast motion at t=t₀; otherwise, pixel (x,y) is in slow motion. If M(x,y)=0, pixel (x,y) may be considered still. The value of pixel change threshold u may be any suitable number depending on the particular application. For example, computer simulations show that if u is between 0.1 and 0.25, and preferably 0.15, good-processing results are obtained for many popular applications.

In one aspect, three consecutive horizontal lines may be considered for determining if a pixel is in a fast motion, with the current line in the middle. A criteria for a pixel to be in a fast motion may be set such that two of the three consecutive lines must satisfy inequality (5), given as follows:
N(x,y)=((M(x,y−1)>u)+(M(x,y)>u)+(M(x,y+1)>u))>1, (6)
wherein each of terms (M(x,y−1)>u), (M(x,y)>u), and (M(x,y+1)>u) has a Boolean value of either 0 or 1, and (x, y−1), (x,y), (x, y+1) are vertically neighboring pixels.

One skilled in the art would now understand that N(x,y) indicates a normalized motion of pixel (x, y) at t=t₀, where a maximum value of 3 corresponds to a motion of 3\sqrt{2} pixels per frame time. That is, a value of N(x,y)=3 means that three neighboring lines have changes (i.e., motion) above the threshold. This will occur whenever a 3×3 square of pixels exhibits motion between two frames. Since the greatest distance between pixels in a 3×3 square is 3\sqrt{2}, this is the amount of motion represented by a value of N(x,y)=3. Because N(x,y) is calculated from M(x,y), which is based on a spatial average of neighboring pixels of (x,y), pixel noise may be effectively suppressed in the representation of motion of pixel (x,y) by N(x,y). Further, because generally the inter-dependency of artifacts does not extend beyond one horizontal line, the criteria given in inequality (6) will effectively suppress artifacts.

Consistent with the present invention, if the amount of motion of the pixel is equal to or below the threshold, the pixel value is retained, at 18. However, if the amount of motion is above the threshold, the pixel value is replaced by a filtered value, at 20. Consistent with the present invention, temporal filtering is applied to filter the slow-motion or still pixels. Thus, image blur caused by spatial filtering may be obviated. Also, because the filtering is only applied to slow-motion or still pixels, motion blur caused in fast-motion pixels may be avoided. In one aspect, the temporal filtering may be implemented by replacing each color component of a pixel that is still or in a slow motion at t=t₀ with an estimate thereof, while retaining the pixels determined to be in a fast motion. For example, the estimate may be chosen to be a median value of the respective color components at t=t₀₋₁ t=t₀, and t=t₀₊₁.

Assuming a frame size of X pixels in the horizontal direction and Y pixels in the vertical direction, a pseudo-source code may thus be created to reflect the above-described area-selected filtering method:

for( y = 0; y < Y; y++ )

for( x = 0; x < X; x++ ) {

calculate N(x,y)
if(N(x,y) > 1) {

Rᵣ(x,y) = Median (Cᵣ(x,y), Fᵣ(x,y), Pᵣ(x,y))
R_{g}(x,y) = Median (C_{g}(x,y), F_{g}(x,y), P_{g}(x,y))
Rₕ(x,y) = Median (C_{b}(x,y), F_{b}(x,y), Pₕ(x,y))
}

else

{
\overline{R}(x,y) = \overline{C}(x,y)
}

},

wherein [symbol] (x,y), a vector composition of three color components Rᵣ(x,y), R_{g}(x,y), and R_{b}(x,y), is the result of filtering pixel [symbol] (x,y). After all pixels of the frame have been processed, the retained or replaced pixel values of the frame are stored, at 22.

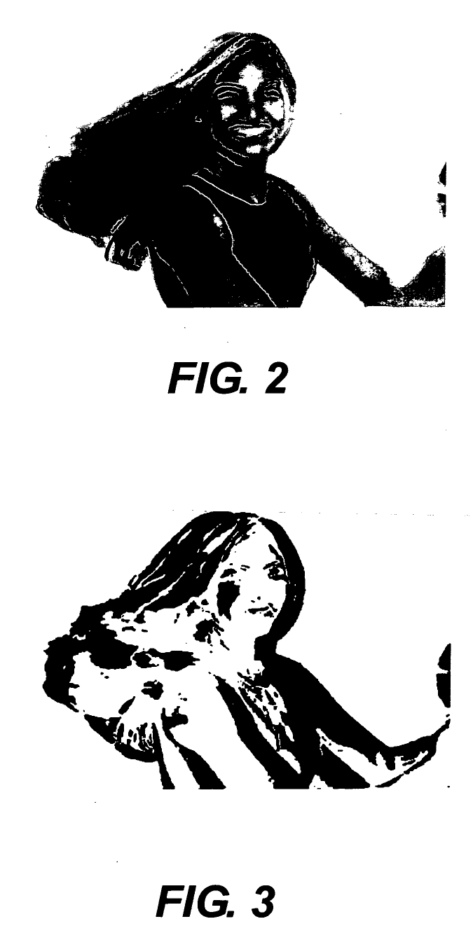

Computer simulation has been performed using the above code and a simulation result is shown in FIGS. 2 and 3, wherein FIG. 2 shows an original video frame of a person in the process of turning around, and FIG. 3 shows in black those portions of the frame that are masked out from filtering due to high motion.

As compared to conventional filtering methods, which require computing both the magnitude and direction of the motion of each pixel to estimate the pixel status at a certain moment, the filtering method consistent with the present invention only requires computing the magnitude of pixel motions. Therefore, the area-selected filtering method is much more cost-effective.

Although it was assumed that the video comprises progressive images, one skilled in the art should understand that the above-described filtering method may also be applied to process a video signal comprising interlaced image frames. For example, each frame may be treated as two separate fields, a first field comprising odd lines of the frame and a second field comprising even lines of the frame. The area-selected filtering method may then be applied to the first field and the second field separately. Thus, for interlaced images, inequality (6) becomes inequality (7):
N(x,y)=((M(x,y−2)>u)+(M(x,y)>u)+(M(x,y+2)>u))>1. (7)
In other words, only three consecutive lines in the same field are considered.

Also, in calculating the spatial average of each pixel in formulae (1)˜(3), only three horizontally neighboring pixels were considered. However, one skilled in the art would understand that the number of pixels in calculating the spatial average is not limited to three, but rather in certain applications may be another appropriate value. Clearly, a smaller number of pixels in calculating the spatial average may result in a less satisfactory suppression of pixel noise, while a larger number may cause significant increase in the burden on a processor performing the calculation. Similarly, more or less than three consecutive horizontal lines may be considered in inequality (6) for reducing the artifacts.

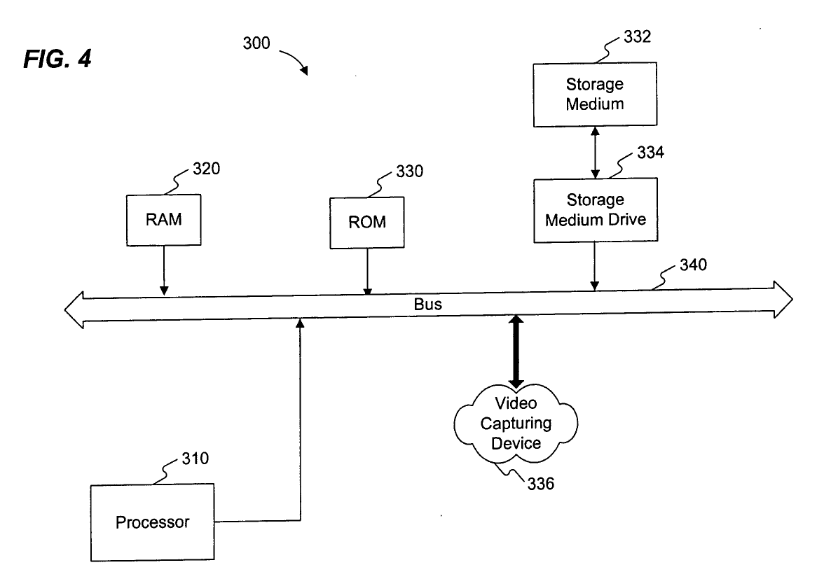

Consistent with the present invention, the area-selected filtering method may be implemented in a computer system or in a software that is stored in a computer-readable media. Such implementation is described below with reference to FIG. 4, which shows a computer system 300 in which the area-selected filtering method consistent with the present invention may be implemented.

Referring to FIG. 4, system 300 includes a processor 310 (which may be implemented with a conventional microprocessor), a random access memory (RAM) 320 for temporary storage of information, and a read only memory (ROM) 320 for permanent storage of information. A bus 330 interconnects these components of computer system 300. A storage medium 332 may be connected through a storage medium drive 334 for storing data and also exchanging data with components of computer system 300. Storage medium 332 may be, for example, a diskette, CD-ROM, and hard drive. Computer system 300 is also connectable to a video capturing device 336 for receiving video images captured thereby.

In one aspect, computer system 300 may be implemented as a personal computer, in which case computer system 300 may also include input devices such as a keyboard and a mouse and output devices such as a monitor and speakers (not shown). Processor 310 accordingly may be a central processing unit (CPU). A software program implementing the area-selected filtering method consistent with the present invention may be stored in storage medium 332, such that processor 310 controls the loading of the software program from storage medium 332 to RAM 320 and the execution thereof.

Video images captured by video capturing device 336 may be processed by processor 310 executing instructions contained either in the software program being loaded into RAM 320 or stored in ROM 330. In one aspect, the video images are transmitted from video capturing device 336 at the same time while the images are processed by processor 310. In another aspect, computer system 300 first transfers the video images from video capturing device 336 to storage medium 332, and then loads the video images from storage medium 332 to RAM 320 prior to processing them in processor 310. The results of the video image processing may then be stored in storage medium 32.

In another aspect, computer system 300 may be implemented as an stand-alone image processor, wherein ROM 330 which permanently stores a set of instructions to perform the area-selected filtering method consistent with the present invention. As will be understood by one skilled in the art, other system configurations incorporating processing devices and storage media may be used to execute the methods described above.

The foregoing description of possible implementations consistent with the present invention does not represent a comprehensive list of all such implementations or all variations of the implementations described. The description of only some implementations should not be construed as an intent to exclude other implementations. One skilled in the art will understand how to implement the invention in the appended claims in may other ways, using equivalents and alternatives that do not depart from the scope of the following claims. Moreover, unless indicated to the contrary in the preceding description, none of the components described in the implementations is essential to the invention.

What is claimed is:

1. A method for processing a video signal having a plurality of sequential frames comprising an array of pixels each having a pixel value and arranged in a plurality of horizontal lines, the method comprising:
receiving a selected frame of the video signal;
processing the selected frame by:
determining an amount of motion of pixels of the selected frame;
retaining pixel values of the pixels of the selected frame if the amount of motion in the pixels of the selected frame is greater than a pixel change threshold; and
replacing the pixel values of the pixels of the selected frame with filtered pixel values if the amount of motion in the pixels of the selected frame is equal to or less than the pixel change threshold; and
storing the retained pixel values and filtered pixel values of the selected frame.

2. The method of claim 1, wherein determining an amount of motion of a pixel comprises comparing the pixel value of the pixel with the pixel values of corresponding pixels of at least one frame other than the selected frame.

3. The method of claim 1, wherein determining an amount of motion of a pixel of the selected frame comprises
calculating a first average of the pixel value of the pixel and the pixel value of at least one neighboring pixel in the same horizontal line of the selected frame;
calculating a second average of at least two pixels in at least one neighboring frame; wherein the at least two pixels in the at least one neighboring frame correspond in position within their respective frame to the positions of the pixel and the at least one neighboring pixel of the selected frame; and
calculating a pixel change of the pixel of the selected frame by comparing the first and second averages.

4. The method of claim 3, wherein calculating the first average comprises calculating an average of the pixel and two neighboring pixels in the same horizontal line of the selected frame, the two neighboring pixels having positions on opposite sides of the pixel.

5. The method of claim 3, wherein the at least one neighboring frame comprises the frame sequentially before the selected frame and the frame sequentially after the selected frame.

6. The method of claim 3, wherein each pixel comprises a plurality of color component values, and calculating the first and second averages comprises calculating respective averages for each of the color components.

7. The method of claim 6, wherein:
the plurality of color component values comprises red, green, and blue color component values;
each color component value has a normalized value between 0 and 1; and
the pixel change threshold is chosen to be 0.15.

8. The method of claim 6, wherein the at least one neighboring frame comprises the frame sequentially before the selected frame and the frame sequentially after the selected frame, and the pixel change of the pixel is equal to the maximum one of the three differences of the respective averages of each color component between the selected frame and the frame sequentially before the selected frame and the three differences of the respective averages of each color component between the selected frame and the frame sequentially after the selected frame.

9. The method of claim 1, wherein a filtered pixel value for a pixel in the selected frame comprises an estimate based on the pixel value of the pixel and the pixel value of at least one other pixel of at least one other frame sequentially before or after the selected frame, the position of the at least one other pixel in the at least one other frame corresponding to the position of the pixel in the selected frame.

10. The method of claim 9, wherein the estimate comprises a median.

11. The method of claim 1, further comprising receiving a plurality of other frames of the video signal, and repeating processing the selected frame and storing the retained pixel values and filtered pixel values of the selected frame for the other frames.

12. The method of claim 1, wherein the selected frame comprises a first field comprising odd numbered lines of the frame and a second field comprising even numbered lines of the frame.

13. A method for processing a video signal having a plurality of sequential frames comprising an array of pixels each having a pixel value and arranged in a plurality of horizontal lines, the method comprising:
receiving a selected frame of the video signal;
processing at least a first pixel of the selected frame by:
determining a first amount of pixel change in the first pixel, wherein the first pixel is in a first line of the selected frame;
determining a second amount of pixel change in a second pixel, the second pixel being in a second line of the selected frame and vertically adjacent to the first pixel;
determining a third amount of pixel change in a third pixel, the third pixel being in a third line of the selected frame and vertically adjacent to the first pixel;
retaining the pixel value of the first pixel if at least two of the first, second, and third amounts of pixel change are greater than a pixel change threshold; and
replacing the pixel value of the first pixel with a filtered pixel value if at least two of the first, second, and third amounts of pixel change are equal to or less than the pixel change threshold; and
storing the pixel values and filtered pixel values of the selected frame.

14. The method of claim 13, wherein determining each of the first, second, and third amounts of pixel change comprises comparing the pixel value of a respective one of the first, second, and third pixels with values of corresponding pixels of at least one frame other than the selected frame.

15. The method of claim 13, wherein determining each of the first, second, and third amounts of pixel change comprises:
calculating a first average of the pixel value of a respective one of the first, second, and third pixels and the pixel value of at least one neighboring pixel in the same horizontal line of the selected frame;
calculating a second average of at least two pixels in at least one neighboring frame, wherein the at least two pixels in the at least one neighboring frame correspond in position within their respective frame to the positions of the respective one of the first, second, and third pixels and the at least one neighboring pixel of the selected frame; and
calculating a pixel change of the respective one of the first, second, and third pixels of the selected frame by comparing the first and second averages.

16. The method of claim 15, wherein calculating the first average comprises calculating an average of the respective one of the first, second, and third pixels and two neighboring pixels in the same horizontal line of the selected frame, the two neighboring pixels having positions on opposite sides of the respective one of the first, second, and third pixels.

17. The method of claim 15, wherein the at least one neighboring frame comprises the frame sequentially before the selected frame and the frame sequentially after the selected frame.

18. The method of claim 15, wherein each pixel comprises a plurality of color component values, and calculating the first and second averages comprises calculating respective averages for each of the color components.

19. The method of claim 18, wherein:
the plurality of color component values comprises red, green, and blue component values;
each color component value has a normalized value between 0 and 1; and
the pixel change threshold is chosen to be 0.15.

20. The method of claim 18, wherein the at least one neighboring frame comprises the frame sequentially before the selected frame and the frame sequentially after the selected frame, and the pixel change of a pixel is equal to the maximum one of the three differences of the respective averages of each color component between the selected frame and the frame sequentially before the selected frame and the three differences of the respective averages of each color component between the selected frame and the frame sequentially after the selected frame.

21. The method of claim 13, wherein the filtered pixel value comprises an estimate based on the pixel value of the first pixel and pixel values of at least one other pixel of at least one second frame sequentially before or after the selected frame, the position of the at least one other pixel in the at least one second frame corresponding to the position of the first pixel in the selected frame.

22. The method of claim 21, wherein the estimate comprises a median.

23. The method of claim 13, wherein processing at least a first pixel of the selected frame comprises processing a plurality of pixels of the selected frame.

24. The method of claim 23, wherein processing at least a first pixel of the selected frame comprises processing each pixel of the selected frame.

25. The method of claim 13, comprising:
receiving a plurality of frames;
processing at least a first pixel of the plurality of frames; and
storing the plurality of frames.

26. A method for processing a video signal having a plurality of sequential frames comprising an array of pixels each having a pixel value and arranged in a plurality of horizontal lines, wherein the plurality of horizontal lines are grouped into a first field including odd lines of a frame and a second field including even lines of a frame, the method comprising:
receiving a selected frame of the video signal;
processing at least a first pixel of one field of the first and second fields of the selected frame by:
determining a first amount of pixel change in the first pixel, wherein the first pixel is in a first line of the one field of the selected frame;
determining a second amount of pixel change in a second pixel, the second pixel being in a second line of the one field the selected frame and vertically adjacent to the first pixel;
determining a third amount of pixel change in a third pixel, the third pixel being, in a third line of the one field the selected frame and vertically adjacent to the first pixel;
retaining the pixel value of the first pixel if at least two of the first, second, and third amounts of pixel change are greater than a pixel change threshold; and
replacing the pixel value of the first pixel with a filtered pixel value if at least two of the first, second, and third amounts of pixel change are equal to or less than the pixel change threshold; and
storing the pixel values and filtered pixel values of the one field of the selected frame.

27. The method of claim 26, wherein determining each of the first, second, and third amounts of pixel change comprises comparing the pixel value of a respective one of the first, second, and third pixels with values of corresponding pixels of at least one frame other than the selected frame.

28. The method of claim 26, wherein determining each of the first, second, and third amounts of pixel change comprises:
calculating a first average of the pixel value of a respective one of the first, second, and third pixels and the pixel value of at least one neighboring pixel in the same horizontal line of the one field of the selected frame;
calculating a second average of at least two pixels in at least one neighboring frame, wherein the at least two pixels in the at least one neighboring frame correspond in position within their respective frame to the positions of the respective one of the first, second, and third pixels and the at least one neighboring pixel of the one field of the selected frame; and
calculating a pixel change of the respective one of the first, second, and third pixels of the one field the selected frame by comparing the first and second averages.

29. The method of claim 28, wherein calculating the first average comprises calculating an average of the respective one of the first, second, and third pixels and two neighboring pixels in the same horizontal line of the one field of the selected frame, the two neighboring pixels having positions on opposite sides of the respective one of the first, second, and third pixels.

30. The method of claim 28, wherein the at least one neighboring frame comprises the frame sequentially before the selected frame and the frame sequentially after the selected frame.

31. The method of claim 28, wherein each pixel comprises red, green, and blue color component values, and calculating the first and second averages comprises calculating respective averages for each of the color components.

32. The method of claim 31, wherein
each color component value has a normalized value between 0 and 1; and
the pixel change threshold is chosen to be 0.15.

33. The method of claim 31, wherein the at least one neighboring frame comprises the frame sequentially before the selected frame and the frame sequentially after the selected frame, and the pixel change of a pixel is equal to the maximum one of the three differences of the respective averages of each color component between the selected frame and the frame sequentially before the selected frame and the three differences of the respective averages of each color component between the selected frame and the frame sequentially after the selected frame.

34. The method of claim 26, wherein the filtered pixel value comprises an estimate based on the pixel value of the first pixel and pixel values of at least one other pixel of at least one second frame sequentially before or after the selected frame, the position of the at least one other pixel in the at least one second frame corresponding to the position of the first pixel in the selected frame.

35. The method of claim 34, wherein the estimate comprises a median.

36. The method of claim 26, wherein processing at least a first pixel of the one field of the selected frame comprises processing a plurality of pixels of the one field of the selected frame.

37. The method of claim 36, wherein processing at least a first pixel of the one field of the selected frame comprises processing each pixel of the one field of the selected frame.

38. The method of claim 36, further comprising repeating processing at least a first pixel of the one field of the selected frame comprises for the other one of the first and second fields of the selected frame.

39. The method of claim 26, comprising:
receiving a plurality of frames;
processing at least a first pixel of one of the first and second fields of the plurality of frames; and
storing the plurality of frames.

40. A computer system connectable to a video capturing device for receiving a video signal having a plurality of sequential frames comprising an array of pixels each having a pixel value and arranged in a plurality of horizontal lines, the system comprising:
a memory for storing a set of instructions implementing a method for processing the plurality of sequential frames, the method comprising:
receiving a selected frame of the video signal;
processing the selected frame by:
determining an amount of motion of pixels of the selected frame;
retaining pixel values of the pixels of the selected frame if the amount of motion in the pixels of the selected frame is greater than a pixel change threshold; and
replacing the pixel values of the pixels of the selected frame with filtered pixel values if the amount of motion in the pixels of the selected frame is equal to or less than the pixel change threshold; and
storing the retained pixel values and filtered pixel values of the selected frame; and
a processor for executing the set of instructions.

41. The system of claim 40, wherein determining an amount of motion of a pixel comprises comparing the pixel value of the pixel with the pixel values of corresponding pixels of at least one frame other than the selected frame.

42. The system of claim 40, wherein determining an amount of motion of a pixel of the selected frame comprises calculating a first average of the pixel value of the pixel and the pixel value of at least one neighboring pixel in the same horizontal line of the selected frame;
calculating a second average of at least two pixels in at least one neighboring frame; wherein the at least two pixels in the at least one neighboring frame correspond in position within their respective frame to the positions of the pixel and the at least one neighboring pixel of the selected frame; and
calculating a pixel change of the pixel of the selected frame by comparing the first and second averages.

43. The system of claim 42, wherein calculating the first average comprises calculating an average of the pixel and two neighboring pixels in the same horizontal line of the selected frame, the two neighboring pixels having positions on opposite sides of the pixel.

44. The system of claim 42, wherein the at least one neighboring frame comprises the frame sequentially before the selected frame and the frame sequentially after the selected frame.

45. The system of claim 42, wherein each pixel comprises a plurality of color component values, and calculating the first and second averages comprises calculating respective averages for each of the color components.

46. The system of claim 45, wherein:
the plurality of color component values comprises red, green, and blue component values;
each color component value has a normalized value between 0 and 1; and
the pixel change threshold is chosen to be 0.15.

47. The system of claim 45, wherein the at least one neighboring frame comprises the frame sequentially before the selected frame and the frame sequentially after the selected frame, and the pixel change of the pixel is equal to the maximum one of the three differences of the respective averages of each color component between the selected frame and the frame sequentially before the selected frame and the three differences of the respective averages of each color component between the selected frame and the frame sequentially after the selected frame.

48. The system of claim 40, wherein a filtered pixel value for a pixel in the selected frame comprises an estimate based on the pixel value of the pixel and the pixel value of at least one other pixel of at least one other frame sequentially before or after the selected frame, the position of the at least one other pixel in the at least one other frame corresponding to the position of the pixel in the selected frame.

49. The system of claim 48, wherein the estimate comprises a median.

50. The system of claim 40, further comprising receiving a plurality of other frames of the video signal, and repeating processing the selected frame and storing the retained pixel values and filtered pixel values of the selected frame for the other frames.

51. The system of claim 40, wherein the system is connectable to a storage medium and the storing comprises storing the retained pixel values and filtered pixel values of the selected frame in the storage medium.

52. The system of claim 51, wherein the storage medium comprises at least one of a diskette, a CD-ROM, and a hard disk.

53. A computer system connectable to a video capturing device for receiving a video signal having a plurality of sequential frames comprising an array of pixels each having a pixel value and arranged in a plurality of horizontal lines, the system comprising:
a read-only memory (ROM) for storing a set of instructions implementing a method for processing the plurality of sequential frames, the method comprising:
receiving a selected frame of the video signal;
processing at least a first pixel of the selected frame by:
determining a first amount of pixel change in the first pixel, wherein the first pixel is in a first line of the selected frame;
determining a second amount of pixel change in a second pixel, the second pixel being in a second line of the selected frame and vertically adjacent to the first pixel;
determining a third amount of pixel change in a third pixel, the third pixel being in a third line of the selected frame and vertically adjacent to the first pixel;
retaining the pixel value of the first pixel if at least two of the first, second, and third amounts of pixel change are greater than a pixel change threshold; and
replacing the pixel value of the first pixel with a filtered pixel value if at least two of the first, second, and third amounts of pixel change are equal to or less than the pixel change threshold; and
storing the pixel values and filtered pixel values of the selected frame; and
a processor for executing the set of instructions.

54. The system of claim 53, wherein determining each of the first, second, and third amounts of pixel change comprises comparing the pixel value of a respective one of the first, second, and third pixels with values of corresponding pixels of at least one frame other than the selected frame.

55. The system of claim 53, wherein determining each of the first, second, and third amounts of motion comprises:
calculating a first average of the pixel value of a respective one of the first, second, and third pixels and the pixel value of at least one neighboring pixel in the same horizontal line of the selected frame;
calculating a second average of at least two pixels in at least one neighboring frame, wherein the at least two pixels in the at least one neighboring frame correspond in position within their respective frame to the positions of the respective one of the first, second, and third pixels and the at least one neighboring pixel of the selected frame; and
calculating a pixel change of the respective one of the first, second, and third pixels of the selected frame by comparing the first and second averages.

56. The system of claim 55, wherein calculating the first average comprises calculating an average of the respective one of the first, second, and third pixels and two neighboring pixels in the same horizontal line of the selected frame, the two neighboring pixels having positions on opposite sides of the respective one of the first, second, and third pixels.

57. The system of claim 55, wherein the at least one neighboring frame comprises the frame sequentially before the selected frame and the frame sequentially after the selected frame.

58. The system of claim 55, wherein each pixel comprises a plurality of color component values, and calculating the first and second averages comprises calculating respective averages for each of the color components.

59. The system of claim 58, wherein:
the plurality of color component values comprises red, green, and blue component values;
each color component value has a normalized value between 0 and 1; and
the pixel change threshold is chosen to be 0.15.

60. The system of claim 58, wherein the at least one neighboring frame comprises the frame sequentially before the selected frame and the frame sequentially after the selected frame, and the pixel change of a pixel is equal to the maximum one of the three differences of the respective averages of each color component between the selected frame and the frame sequentially before the selected frame and the three differences of the respective averages of each color component between the selected frame and the frame sequentially after the selected frame.

61. The system of claim 53, wherein the filtered pixel value comprises an estimate based on the pixel value of the first pixel and pixel values of at least one other pixel of at least one second frame sequentially before or after the selected frame, the position of the at least one other pixel in the at least one second frame corresponding to the position of the first pixel in the selected frame.

62. The system of claim 61, wherein the estimate comprises a median.

63. The system of claim 53, wherein processing at least a first pixel of the selected frame comprises processing a plurality of pixels of the selected frame.

64. The system of claim 63, wherein processing at least a first pixel of the selected frame comprises processing each pixel of the selected frame.

65. The system of claim 53, comprising:
receiving a plurality of frames;
processing at least a first pixel of the plurality of frames; and
storing the plurality of frames.

66. The system of claim 53, wherein the system is connectable to a storage medium and the storing comprises storing the retained pixel values and filtered pixel values of the selected frame in the storage medium.

67. The system of claim 66, wherein the storage medium comprises at least one of diskette, CD-ROM, and hard disk.

68. A computer system connectable to a video capturing device for receiving a video signal having a plurality of sequential frames comprising an array of pixels each having a pixel value and arranged in a plurality of horizontal lines, wherein the plurality of horizontal lines are grouped into a first field including odd lines of a frame and a second field including even lines of a frame, the system comprising:
a read-only memory (ROM) for storing a set of instructions implementing a method for processing the plurality of sequential frames, the method comprising:
receiving a selected frame of the video signal;
processing at least a first pixel of one field of the first and second fields of the selected frame by:
determining a first amount of pixel change in the first pixel, wherein the first pixel is in a first line of the one field of the selected frame;
determining a second amount of pixel change in a second pixel, the second pixel being in a second line of the one field the selected frame and vertically adjacent to the first pixel;
determining a third amount of pixel change in a third pixel, the third pixel being in a third line of the one field the selected frame and vertically adjacent to the first pixel;
retaining the pixel value of the first pixel if at least two of the first, second, and third amounts of pixel change are greater than a pixel change threshold; and
replacing the pixel value of the first pixel with a filtered pixel value if at least two of the first, second, and third amounts of pixel change are equal to or less than the pixel change threshold; and
storing the pixel values and filtered pixel values of the one field of the selected frame; and
a processor for executing the set of instructions.

69. The system of claim 68, wherein determining each of the first, second, and third amounts of pixel change comprises comparing the pixel value of the respective one of the first, second, and third pixels with values of corresponding pixels of at least one frame other than the selected frame.

70. The system of claim 68, wherein determining each of the first, second, and third amounts of pixel change comprises:
calculating a first average of the pixel value of a respective one of the first, second, and third pixels and the pixel value of at least one neighboring pixel in the same horizontal line of the one field of the selected frame;
calculating a second average of at least two pixels in at least one neighboring frame, wherein the at least two pixels in the at least one neighboring frame correspond in position within their respective frame to the positions of the respective one of the first, second, and third pixels and the at least one neighboring pixel of the one field of the selected frame; and
calculating a pixel change of the respective one of the first, second, and third pixels of the one field the selected frame by comparing the first and second averages.

71. The system of claim 70, wherein calculating the first average comprises calculating an average of the respective one of the first, second, and third pixels and two neighboring pixels in the same horizontal line of the one field of the selected frame, the two neighboring pixels having positions on opposite sides of the respective one of the first, second, and third pixels.

72. The system of claim 70, wherein the at least one neighboring frame comprises the frame sequentially before the selected frame and the frame sequentially after the selected frame.

73. The system of claim 70, wherein each pixel comprises red, green, and blue color component values, and calculating the first and second averages comprises calculating respective averages for each of the color components.

74. The system of claim 73, wherein
each color component value has a normalized value between 0 and 1; and
the pixel change threshold is chosen to be 0.15.

75. The system of claim 73, wherein the at least one neighboring frame comprises the frame sequentially before the selected frame and the frame sequentially after the selected frame, and the pixel change of a pixel is equal to the maximum one of the three differences of the respective averages of each color component between the selected frame and the frame sequentially before the selected frame and the three differences of the respective averages of each color component between the selected frame and the frame sequentially after the selected frame.

76. The system of claim 68, wherein the filtered pixel value comprises an estimate based on the pixel value of the first pixel and pixel values of at least one other pixel of at least one second frame sequentially before or after the selected frame, the position of the at least one other pixel in the at least one second frame corresponding to the position of the first pixel in the selected frame.

77. The system of claim 76, wherein the estimate comprises a median.

78. The system of claim 68, wherein processing at least a first pixel of the one field of the selected frame comprises processing a plurality of pixels of the one field of the selected frame.

79. The system of claim 78, wherein processing at least a first pixel of the one field of the selected frame comprises processing each pixel of the one field of the selected frame.

80. The system of claim 78, further comprising repeating processing at least a first pixel of the one field of the selected frame comprises for the other one of the first and second fields of the selected frame.

81. The system of claim 68, comprising:
receiving a plurality of frames;
processing at least a first pixel of one of the first and second fields of the plurality of frames; and
storing the plurality of frames.

82. The system of claim 68, wherein the system is connectable to a storage medium and the storing comprises storing the retained pixel values and filtered pixel values of the selected frame in the storage medium.

83. The system of claim 82, wherein the storage medium comprises at least one of a diskette, a CD-ROM, and a hard disk.

84. A computer-readable medium containing a program for causing a processor to perform a method for processing a video signal having a plurality of sequential frames comprising an array of pixels each having a pixel value and arranged in a plurality of horizontal lines, the method comprising:
receiving a selected frame of the video signal;
processing the selected frame by:
determining an amount of motion of pixels of the selected frame;
retaining pixel values of the pixels of the selected frame if the amount of motion in the pixels of the selected frame is greater than a pixel change threshold; and
replacing the pixel values of the pixels of the selected frame with filtered pixel values if the amount of motion in the pixels of the selected frame is equal to or less than the pixel change threshold; and
storing the retained pixel values and filtered pixel values of the selected frame.

85. The medium of claim 84, wherein determining an amount of motion of a pixel comprises comparing the pixel value of the pixel with the pixel values of corresponding pixels of at least one frame other than the selected frame.

86. The medium of claim 84, wherein determining an amount of motion of a pixel of the selected frame comprises
calculating a first average of the pixel value of the pixel and the pixel value of at least one neighboring pixel in the same horizontal line of the selected frame;
calculating a second average of at least two pixels in at least one neighboring frame; wherein the at least two pixels in the at least one neighboring frame correspond in position within their respective frame to the positions of the pixel and the at least one neighboring pixel of the selected frame; and
calculating a pixel change of the pixel of the selected frame by comparing the first and second averages.

87. The medium of claim 86, wherein calculating the first average comprises calculating an average of the pixel and two neighboring pixels in the same horizontal line of the selected frame, the two neighboring pixels having positions on opposite sides of the pixel.

88. The medium of claim 86, wherein the at least one neighboring frame comprises the frame sequentially before the selected frame and the frame sequentially after the selected frame.

89. The medium of claim 86, wherein each pixel comprises a plurality of color component values, and calculating the first and second averages comprises calculating respective averages for each of the color components.

90. The medium of claim 89, wherein:
the plurality of color component values comprises red, green, and blue color component values;
each color component value has a normalized value between 0 and 1; and
the pixel change threshold is chosen to be 0.15.

91. The medium of claim 89, wherein the at least one neighboring frame comprises the frame sequentially before the selected frame and the frame sequentially after the selected frame, and the pixel change of the pixel is equal to the maximum one of the three differences of the respective averages of each color component between the selected frame and the frame sequentially before the selected frame and the three differences of the respective averages of each color component between the selected frame and the frame sequentially after the selected frame.

92. The medium of claim 84, wherein a filtered pixel value for a pixel in the selected frame comprises an estimate based on the pixel value of the pixel and the pixel value of at least one other pixel of at least one other frame sequentially before or after the selected frame, the position of the at least one other pixel in the at least one other frame corresponding to the position of the pixel in the selected frame.

93. The medium of claim 92, wherein the estimate comprises a median.

94. The medium of claim 84, further comprising receiving a plurality of other frames of the video signal, and repeating processing the selected frame and storing the retained pixel values and filtered pixel values of the selected frame for the other frames.

95. The medium of claim 84, wherein the medium is one of diskette, CD-ROM, and hard disk.

96. A computer-readable medium containing a program for causing a processor to perform a method for processing a video signal having a plurality of sequential frames comprising an array of pixels each having a pixel value and arranged in a plurality of horizontal lines, the method comprising:
receiving a selected frame of the video signal;
processing at least a first pixel of the selected frame by:
determining a first amount of pixel change in the first pixel, wherein the first pixel is in a first line of the selected frame;
determining a second amount of pixel change in a second pixel, the second pixel being in a second line of the selected frame and vertically adjacent to the first pixel;
determining a third amount of pixel change in a third pixel, the third pixel being in a third line of the selected frame and vertically adjacent to the first pixel;
retaining the pixel value of the first pixel if at least two of the first, second, and third amounts of pixel change are greater than a pixel change threshold; and
replacing the pixel value of the first pixel with a filtered pixel value if at least two of the first, second, and third amounts of pixel change are equal to or less than the pixel change threshold; and
storing the pixel values and filtered pixel values of the selected frame.

97. The medium of claim 96, wherein determining each of the first, second, and third amounts of pixel change comprises comparing the pixel value of a respective one of the first, second, and third pixels with values of corresponding pixels of at least one frame other than the selected frame.

98. The medium of claim 96, wherein determining each of the first, second, and third amounts of pixel change comprises
calculating a first average of the pixel value of a respective one of the first, second, and third pixels and the pixel value of at least one neighboring pixel in the same horizontal line of the selected frame;
calculating a second average of at least two pixels in at least one neighboring frame, wherein the at least two pixels in the at least one neighboring frame correspond in position within their respective frame to the positions of the respective one of the first, second, and third pixels and the at least one neighboring pixel of the selected frame; and
calculating a pixel change of the respective one of the first, second, and third pixels of the selected frame by comparing the first and second averages.

99. The medium of claim 98, wherein calculating the first average comprises calculating an average of the respective one of the first, second, and third pixels and two neighboring pixels in the same horizontal line of the selected frame, the two neighboring pixels having positions on opposite sides of the respective one of the first, second, and third pixels.

100. The medium of claim 98, wherein the at least one neighboring frame comprises the frame sequentially before the selected frame and the frame sequentially after the selected frame.

101. The medium of claim 98, wherein each pixel comprises a plurality of color component values, and calculating the first and second averages comprises calculating respective averages for each of the color components.

102. The medium of claim 101, wherein;
the plurality of color component values comprises red, green, and blue color component values;
each color component value has a normalized value between 0 and 1; and
the pixel change threshold is chosen to be 0.15.

103. The medium of claim 101, wherein the at least one neighboring frame comprises the frame sequentially before the selected frame and the frame sequentially after the selected frame, and the pixel change of a pixel is equal to the maximum one of the three differences of the respective averages of each color component between the selected frame and the frame sequentially before the selected frame and the three differences of the respective averages of each color component between the selected frame and the frame sequentially after the selected frame.

104. The medium of claim 96, wherein the filtered pixel value comprises an estimate based on the pixel value of the first pixel and pixel values of at least one other pixel of at least one second frame sequentially before or after the selected frame, the position of the at least one other pixel in the at least one second frame corresponding to the position of the first pixel in the selected frame.

105. The medium of claim 104, wherein the estimate comprises a median.

106. The medium of claim 96, wherein processing at least a first pixel of the selected frame comprises processing a plurality of pixels of the selected frame.

107. The medium of claim 106, wherein processing at least a first pixel of the selected frame comprises processing each pixel of the selected frame.

108. The medium of claim 96, comprising:
receiving a plurality of frames;
processing at least a first pixel of the plurality of frames; and
storing the plurality of frames.

109. The medium of claim 96, wherein the storage medium is one of diskette, CD-ROM, and hard disk.

110. A computer-readable medium containing a program for causing a processor to perform a method for processing a video signal having a plurality of sequential frames comprising an array of pixels each having a pixel value and arranged in a plurality of horizontal lines, wherein the plurality of horizontal lines are grouped into a first field including odd lines of a frame and a second field including even lines of a frame, the method comprising:
receiving a selected frame of the video signal;
processing at least a first pixel of one field of the first and second fields of the selected frame by:
determining a first amount of pixel change in the first pixel, wherein the first pixel is in a first line of the one field of the selected frame;
determining a second amount of pixel change in a second pixel, the second pixel being in a second line of the one field the selected frame and vertically adjacent to the first pixel;
determining a third amount of pixel change in a third pixel, the third pixel being in a third line of the one field the selected frame and vertically adjacent to the first pixel;
retaining the pixel value of the first pixel if at least two of the first, second, and third amounts of pixel change are greater than a pixel change threshold; and
replacing the pixel value of the first pixel with a filtered pixel value if at least two of the first, second, and third amounts of pixel change are equal to or less than the pixel change threshold; and
storing the pixel values and filtered pixel values of the one field of the selected frame.

111. The medium of claim 110, wherein determining each of the first, second, and third amounts of pixel change comprises comparing the pixel value of a respective one of the first, second, and third pixels with values of corresponding pixels of at least one frame other than the selected frame.

112. The medium of claim 110, wherein determining each of the first, second, and third amounts of pixel change comprises:
calculating a first average of the pixel value of a respective one of the first, second, and third pixels and the pixel value of at least one neighboring pixel in the same horizontal line of the one field of the selected frame;
calculating a second average of at least two pixels in at least one neighboring frame, wherein the at least two pixels in the at least one neighboring frame correspond in position within their respective frame to the positions of the respective one of the first, second, and third pixels and the at least one neighboring pixel of the one field of the selected frame; and
calculating a pixel change of the respective one of the first, second, and third pixels of the one field the selected frame by comparing the first and second averages.

113. The medium of claim 112, wherein calculating the first average comprises calculating an average of the respective one of the first, second, and third pixels and two neighboring pixels in the same horizontal line of the one field of the selected frame, the two neighboring pixels having positions on opposite sides of the respective one of the first, second, and third pixels.

114. The medium of claim 112, wherein the at least one neighboring frame comprises the frame sequentially before the selected frame and the frame sequentially after the selected frame.

115. The medium of claim 112, wherein each pixel comprises red, green, and blue color component values, and calculating the first and second averages comprises calculating respective averages for each of the color components.

116. The medium of claim 115, wherein
each color component value has a normalized value between 0 and 1; and
the pixel change threshold is chosen to be 0.15.

117. The medium of claim 115, wherein the at least one neighboring frame comprises the frame sequentially before the selected frame and the frame sequentially after the selected frame, and the pixel change of a pixel is equal to the maximum one of the three differences of the respective averages of each color component between the selected frame and the frame sequentially before the selected frame and the three differences of the respective averages of each color component between the selected frame and the frame sequentially after the selected frame.

118. The medium of claim 110, wherein the filtered pixel value comprises an estimate based on the pixel value of the first pixel and pixel values of at least one other pixel of at least one second frame sequentially before or after the selected frame, the position of the at least one other pixel in the at least one second frame corresponding to the position of the first pixel in the selected frame.

119. The medium of claim 118, wherein the estimate comprises a median.

120. The medium of claim 110, wherein processing at least a first pixel of the one field of the selected frame comprises processing a plurality of pixels of the one field of the selected frame.

121. The medium of claim 120, wherein processing at least a first pixel of the one field of the selected frame comprises processing each pixel of the one field of the selected frame.

122. The medium of claim 120, further comprising repeating processing at least a first pixel of the one field of the selected frame comprises for the other one of the first and second fields of the selected frame.

123. The medium of claim 110, comprising:
receiving a plurality of frames;
processing at least a first pixel of one of the first and second fields of the plurality of frames; and
storing the plurality of frames.

124. The medium of claim 110, wherein the system is connectable to a storage medium and the storing comprises storing the retained pixel values and filtered pixel values of the selected frame in the storage medium.

125. The medium of claim 124, wherein the storage medium is at least one of one of a diskette, a CD-ROM, and a hard disk.
